(19) United States
(12) Patent Application Publication
(10) Pub. No.: US 2007/0241923 A1
(43) Pub. Date: Oct. 18, 2007

(54) Audible personal identification system for articles

(76) Inventor: Jeanette M. Rothacker, Cleveland, OH (US)

Correspondence Address: BARBARA E. ARNDT, 26 NANTUCKET ROW, CLEVELAND, OH, 44116, US

(21) Appl. No.: 11/399,900

(22) Filed: Apr. 7, 2006

(51) Int. Cl. G08B 25/08

(52) U.S. Cl. 340/692

(57) ABSTRACT

An audible personal identification system for an article comprises (a) a device programmable to record and play back a voice message that includes identification of an article as belonging to an individual; (b) an optional packet for containing the device; (c) a visible marker for fastening to the article to indicate the presence of the device; and (d) an activating means for playing back the voice message. Included is an article to be identified as belonging to an individual, employing the audible personal identification system; a method for identifying an article as belonging to an individual; and a method for using a digital voice recorder for identifying an article as belonging to an individual.

### BACKGROUND OF THE INVENTION

A problem that has plagued both children and adults is the loss, either temporarily or permanently, of garments such as jackets, vests, sweaters, coats and the like, accessories such as sleeping bags, pillows, and the like, and other personal articles such as toys, tote bags, purses, briefcases, back packs, and the like, because of similarities between the article belonging to that individual and an article belonging to another individual who accidentally confuses the two.

Although solutions to the article identification problem, such as permanently-attached name tags for articles of clothing, or detachable name tags or permanently etched identification systems for other articles are known, each of these solutions requires a determined effort on the part of the first individual to provide visual identification of the article and a determined effort on the part of the other individual to seek the identification applied by the first individual. However, as is well known, many persons casually identify an article by its outer appearance only and, being satisfied with that means of identification, often mistakenly retrieve a similar article rather than their own.

Therefore, there is a need for an alternative identification system for articles such as garments and/or other articles belonging to an individual that is visually obvious, while preferably not detracting from the aesthetic appeal of the article.

### SUMMARY OF THE INVENTION

An audible personal identification system for an article comprises (a) a device programmable to record and play back a voice message that includes identification of an article as belonging to an individual; (b) an optional packet for containing the device; (c) a visible marker for fastening to a surface of the article to indicate the presence of the device; and (d) an activating means for playing back the voice message. The marker is suitably prominently visible and is fastenable to an exterior surface of the article and/or to an interior surface of the article. As used herein to describe the visible fastenable marker, the term “article” is intended to broadly include the optional packet for containing the device. That is, the visible marker can also or alternatively be fastenable to an exterior and/or an interior surface of the optional packet. In addition to indicating the presence of the device, the visible marker can also be positioned on the article to indicate the location of the device.

The activating means suitably comprises a play back button or switch of the device that can be activated to play back the recorded voice message. In one non-limiting arrangement, a play back button can be compressibly activated by manually pressing on the article at the location of the device. In another non-limiting arrangement, a play back button or switch can be activated by manually squeezing the article at the location of the device.

As a non-limiting example, a suitable device for use in the audible personal identification system for articles can be a digital voice recorder.

It is contemplated that such an audible personal identification system can be used with articles of clothing such as, but not limited to, coats, jackets, vests, skirts, dresses, sweaters, shirts, pants, and the like. Moreover, such an audible personal identification system can be used with other portable items of a personal nature such as, but not limited to, an identification bracelet, a tote bag, a sleeping bag, a blanket, a pillow, a toy, and the like, or other personal items such as, but not limited to, a purse, a briefcase, a computer-carrying case, a backpack, and the like. Other uses for the audible personal identification system, without limitation, can include jackets, tee shirts, slickers and the like, such as those often provided to groups of persons traveling together, where the articles are often identical or sufficiently similar so as to be confused with each other. In another non-limiting use, the system can be worn on a string, chain, or the like, for example around the neck or the wrist of an individual, and the article to be identified is the individual himself or herself, either individually or as part of a group of individuals. It is also anticipated that the audible personal identification system for an article would be useful to aid individuals such as, but not limited to, visually challenged individuals in identification of articles belonging to them.

Among the advantages of the audible personal identification system according to the invention over a conventional name tag system is that the marker indicating the presence of the system can be prominently visually displayed so that even a casual perusal of the item by another individual is far less likely to result in an inappropriate identification of the article. In certain situations, it can be appropriate to provide enough audible information such that, if the article becomes lost, the identification system can allow return of the lost article to the individual to whom it belongs.

The invention further includes articles such as, but not limited to, garments and personal articles comprising the audible personal identification system, a method for identifying an article as belonging to an individual, and a method for using a voice recorder for identifying an article as belonging to an individual.

### BRIEF DESCRIPTION OF THE DRAWINGS

FIG. 1A is a schematic representation of a digital voice recorder that is commercially available and is suitable as the voice recorder in the audible identification system.

FIG. 1B is a cross-sectional view of the digital voice recorder of FIG. 1B.

FIG. 1C is a schematic representation of another commercially available digital voice recorder suitable for use in the audible identification system.

FIG. 2 is a schematic representation of an optional packet for containing the voice recorder device.

FIG. 3A illustrates an example of a pictorial marker that can also include an indicia.

FIG. 3B illustrates a further example of a marker that includes an indicia.

FIG. 4 is a schematic representation of a garment, a jacket, comprising one or more outside or side pockets for containing the voice recorder device, and the marker on an exterior surface of the jacket.

FIG. 5 illustrates the jacket of FIG. 4 comprising one or more inside pockets for containing the voice recorder device, and the marker on an exterior surface of the jacket.

FIG. 6 illustrates a pocket on the back of the jacket of FIG. 4 for containing the voice recorder device, and the marker on an exterior surface of the pocket.

FIG. 7 is a schematic illustration of the voice recorder contained in an optional packet with the marker on an exterior surface of the packet, and including a means of attachment to a portable article.

FIG. 8 is a schematic illustration of the packet of FIG. 7 attached to a purse or briefcase.

### DETAILED DESCRIPTION OF THE INVENTION

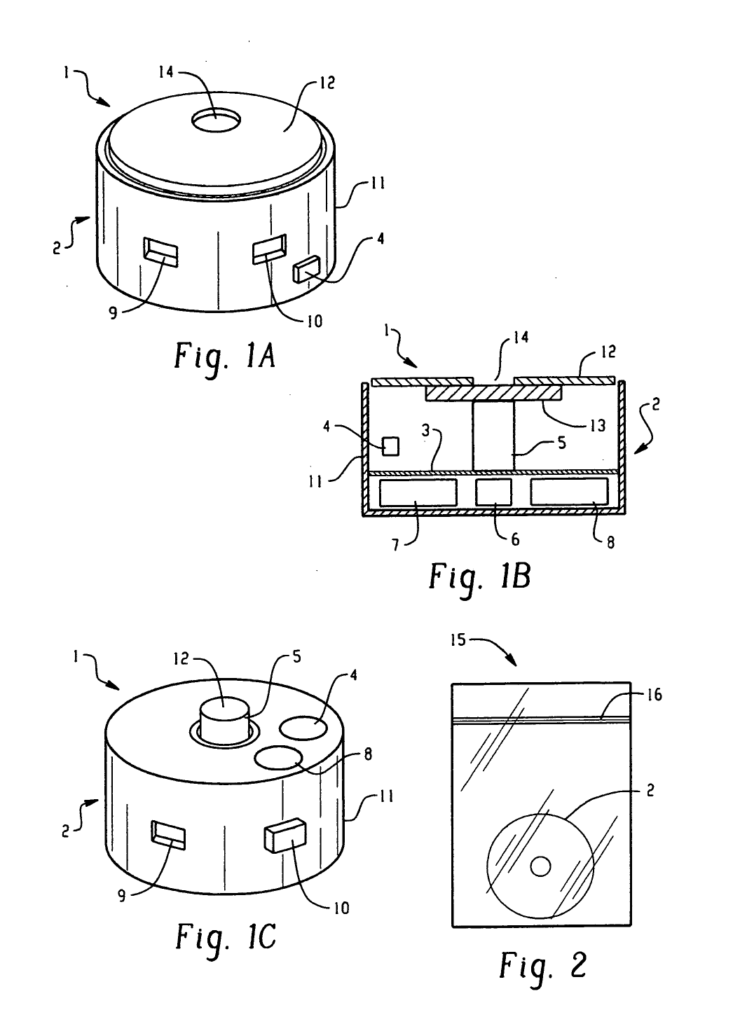

The audible personal identification system for an article, according to the invention, comprises at least three elements illustrated in FIGS. 1 to 3, namely a device programmable to record and play back a voice message that includes identification of an article as belonging to an individual; a marker for fastening to the article to indicate the presence and/or the location of the device; and an activating means for playing back the voice message. For illustrative, non-limiting purposes, representative programmable devices, digital voice recorders, are illustrated in FIGS. 1A and 1C. A cross-sectional view of the digital voice recorder of FIG. 1A is shown in FIG. 1B. The device 1 can comprise a digital voice recorder 2 that can be a self-powered, battery-operated device that is readily commercially available from a number of sources. The digital voice recorder 2 includes a digital voice integrated circuit chip 3 such as an ISD 1000 series, ISD 1100 series, ISD 1200 series, ISD 1400 series chip, and the like, and suitable interface circuitry. Such chips and circuitry are known and are not illustrated here. The selection of the circuit chip depends on the user's preference as to the duration of the time available for recording and playing back of the message.

The digital voice recorder 2 integrally includes the integrated circuit chip 3, a record switch or button 4, a play back button 5, a concealed speaker 6, a concealed recording microphone 7, a battery 8, and an optional indicator 9 of which mode the device is in such as, but not limited to, a play/record indicia, an LED display, and the like. Optionally the voice recorder 2 can include a message delete switch 10. Such digital voice recorders are commercially available. The digital voice recorder 2 suitably includes the circuit elements mounted in a housing such as, but not limited to, a polymeric housing 11 that has a surface 12 that allows access to the play back button 5 for playing back a voice message when the recorder 2 is in the play back mode, by compression of the surface 12 and/or the play back button 5. For example, the digital voice recorder 2 illustrated in FIG. 1A and in cross-section in FIG. 1B has a compressible surface 12 that includes at least one opening 14 for allowing audibility of the play back message. An undersurface of the compressible surface 12 comprises an element 13 that makes contact with and activates a hidden play back button 5 when the surface 12 is compressed.

The digital voice recorder 2 suitably has dimensions compatible with inserting into an opening in the article, for example an opening in a garment such as, but not limited to, a pocket, a hem, a collar, and the like, or an opening in a portable item such as, but not limited to, an exterior or interior pocket in a tote bag, a sleeping bag, a blanket, a pillow, a purse, a briefcase, a computer carrying case, a toy, a backpack, and the like. Alternatively the digital voice recorder 2 suitably has dimensions compatible with being contained in a packet for attachment to such a portable item. As such, a digital voice recorder with suitable dimensions can be obtained commercially or can be custom-configured to a desired dimension. The digital voice recorder is suitably removable from the article for purposes of laundering the article, and the like.

To record a voice message for purposes of identification of the article as belonging to an individual, the recorder 2 is set to the record mode, and the operator records a voice message that includes identification information. The length of the message is limited only by the memory selected for the recorder. The digital voice recorder 2 is then set to the play back mode and the now-programmed digital voice recorder 2 is ready for attachment to the article for which identification is desired.

Referring now to FIG. 2, prior to attachment to an article to be identified, the programmed digital voice recorder 2 can be contained in an optional protective packet 15, that suitably can be a non-waterproof packet, or a water proof packet such as a plastic or a rubber bag, or a water proofed cloth bag, and the like, without limitation. The protective packet 15 can be transparent or opaque. The packet 15 has an open portion 16 for receiving the voice recorder 2 and the open portion 16 is suitably closable, such as by a zipper, a tie, a plastic slide, Velcro®, or the like, without limitation, in order to protect the voice recorder 2 inside. Such a closure can suitably be reopened in order to remove the voice recorder 2. The protective packet 15 can also be used as a storage carrier for the voice recorder 2 when it is not in use and/or is not programmed.

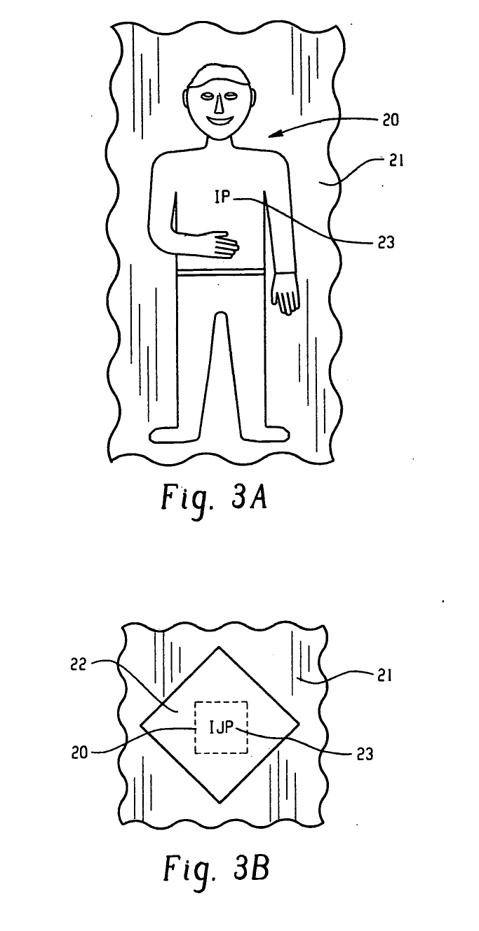

The second element of the audible personal article identification system is illustrated in FIGS. 3A and 3B. A marker 20 for fastening to the article 21 indicates the presence of the voice recorder 22 and, without limitation, is suitably a piece of fabric, leather, and/or plastic and the like, fastenable or attachable to the article 21 by permanent, semi-permanent or removable means such as, but not limited to, an adhesive, sewing, snaps, a hook and loop fastener such as Velcro®, and the like. The marker 20 can have a distinctive shape that can be aesthetically designed to compliment the article 21. The marker 20 is suitably prominently visible and fastened to an exterior surface 22 of the article 21 or to an inner surface of the article provided the article is transparent at the site of the marker and the marker is prominently visible. In addition to indicating the presence of the voice recorder 22, the marker 20 can also indicate the location of the voice recorder 22, such as by means of an indicia 23 that includes information pointing to the device including, but not limited to, an arrow pointing to the location of the device, words or pictures indicating its location, and the like. Moreover, the marker 20 itself can be a picture, arrow or the like, pointing to the device. More suitably, the marker 20 can be located directly over the location of the voice recorder 22. In this example, the marker 20 can indicate in words and/or pictures, and the like, activating means for playing back the voice message. For example, the marker 20 itself, and/or an indicia 23 on the marker 20 can comprise something as simple as the words “press here for identification.”

The indicia 23 on the marker 20 further can be a logo such as, but not limited to, “IP” an abbreviation for “Identi-Packet,” or a logo further identifying the type of article. That is, the logo can further identify a jacket as containing the identification system as “IJP” an abbreviation for “Identi-Jacket-Packet.” The type of logo that can be used is as unlimited and varied as the kinds of articles to be identified by the audible personal identification system.

Articles that can be identified as belonging to an individual can include articles of clothing such as, but not limited to, coats, jackets, vests, skirts, dresses, sweaters, shirts, pants, and the like. Moreover, such an audible personal identification system can be used with other portable items of a personal nature such as, but not limited to, an identification bracelet, a tote bag, a sleeping bag, a blanket, a pillow, a toy, and the like, or other personal items such as, but not limited to, a purse, a briefcase, a computer-carrying case, a backpack, and the like.

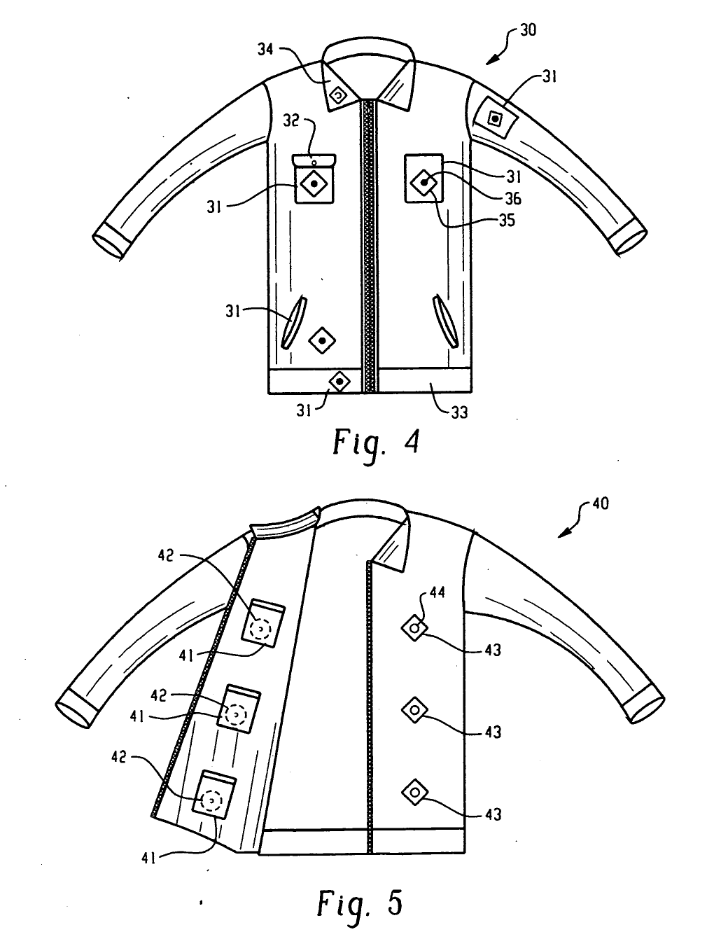

An exemplary, non-limiting garment comprising the identification system described above is illustrated in FIG. 4. The illustrated garment is a typical jacket 30, having a back and a front, a collar, sleeves, pockets, a hem or band at the bottom, and a front opening closable by a closure means including, but not limited to, a zipper, snaps, buttons, Velcro®, and the like. Various unlimited locations of one or more pockets 31 for containing the voice recorder (not shown) include exterior pockets on the front of the jacket that may or may not have a flap 32 to help contain and/or protect the voice recorder, side pockets, sleeve pockets, and the like. Also shown is the jacket 30 having a voice recorder within an opening on the inside of the hem or band 33 at the bottom of the jacket 30 or within an opening in the collar 34 of the jacket 30. The one or more locations of the voice recorder in the one or more pockets 31 is indicated by a marker 35 (diamond shaped in the illustration) with an indicia 36 on an exterior surface of the pocket(s) 31.

FIG. 5 illustrates a typical jacket 40 having one or more pockets 41 inside the jacket for containing a voice recorder 42. A suitable marker 43, with or without an indicia 44 on the exterior surface 45 of the jacket 40 indicates the location of the device 42.

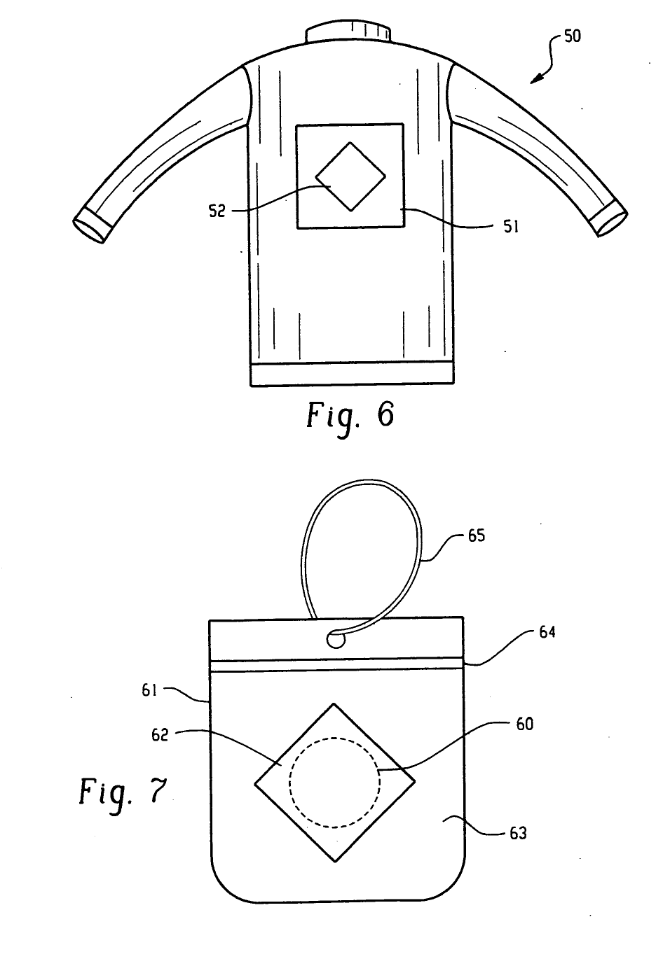

FIG. 6 illustrates a rear view of a typical jacket 50 that has one or more pockets 51 on the back of the jacket 50 for containing the voice recorder, and a marker 52, with or without an indicia for showing the presence and/or the location of the voice recorder.

While FIGS. 4 through 6 illustrate the audible personal identification system for use with a garment, it is recognized that portable articles that are not garments can also contain pockets and, if not, pockets can be permanently or removably attached to them for the purpose of containing and indicating the presence of the system. Such articles can include, but are not limited to, a tote bag, a sleeping bag, a blanket, a pillow, a purse, a briefcase, a computer-carrying case, and the like.

FIG. 7 illustrates the voice recorder 60 contained within a packet 61 that can be water proof or not water proof, clear or opaque. A marker 62 indicating the presence of the voice recorder 60 is attached to an exterior surface 63 of the packet 61. The marker 61 can further comprise a logo, as described above. The packet 61 has an open portion 63 for receiving the voice recorder 60 and the open portion 64 is suitably closable, such as by a zipper, a tie, a plastic slide, Velcro®, or the like, without limitation, in order to protect the voice recorder 60 inside. Such a closure can suitably be reopened in order to remove the voice recorder 60. The packet 61 further can comprise a means of attachment 65 to a portable article. Exemplary means of attachment include, but are not limited to, a strap, a string, a chain, a metal hook apparatus, or the like. Exemplary portable articles to which a packet 61 containing the voice recorder 60 and the marker 62 can be attached include identification bracelets, such as those used for hospital patients, individuals with memory impairment, and the like, a tote bag, a purse, a briefcase, a computer-carrying case, and the like, without limitation.

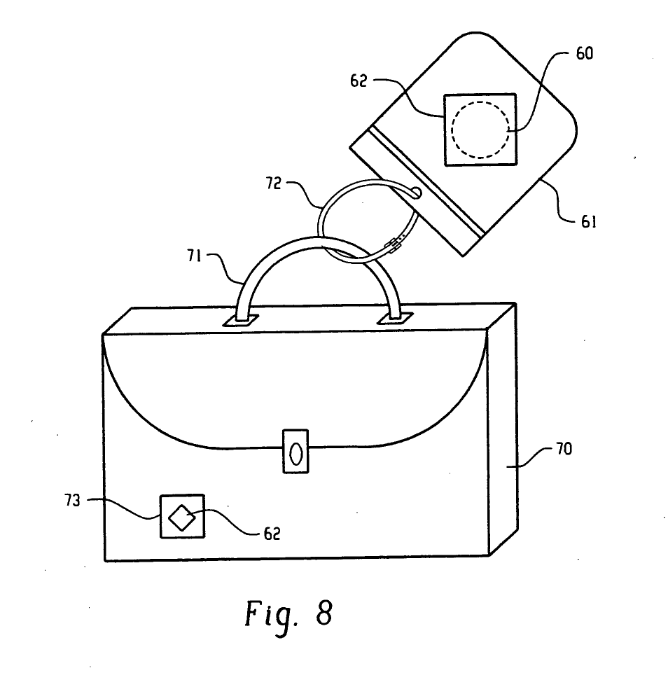

FIG. 8 illustrates the packet 61 containing the voice recorder 60 and the marker 62 illustrated in FIG. 9, attached to a purse or briefcase 70 having a handle 71 to which the packet is attached by a strap 72. In another arrangement, the voice recorder 60 with or without the optional packet can be contained in an exterior or internal pocket 73 of the purse or briefcase 70.

The type and amount of identification information provided on the voice recorder is left to the discretion and judgment of the person providing the information. For example, if the identification system is to be used for an article belonging to a child, it may not be appropriate to include the child's name or any other identifying information about the child that could be used inappropriately by another to cause an unsafe situation for the child. A non-limiting example of an appropriate message for a child's article could be “This is not your jacket. This is my jacket.” In combination with a distinctive marker and/or indicia, an exemplary message such as this could be considered adequate to provide notice to another individual that the article does not belong to that other individual. If the identification system is to be used, for example, as part of an identification bracelet, it could be considered appropriate to include the name of the individual and, perhaps, other information regarding the address of that individual, as needed. For example, a person with memory impairment who might wander away and who carries the audible personal identification system could be identified and returned to his or her appropriate location by specific information provided by the identification system.

A method for identifying an article as belonging to an individual, can comprise the steps of (a) recording a voice message on a recording device with a means for playing back the voice message, wherein the voice message includes identification of an article as belonging to an individual; (b) setting the recording device to a play back mode; (c) optionally placing the device in the play back mode in a packet; (d) attaching the device in the play back mode to the article, wherein the attaching optionally comprises placing the device in a pocket of the article; (e) attaching a visible marker to a surface of the article to indicate the presence of the device; and (f) activating the means for playing back the voice message to identify the article as belonging to the individual.

A method for using a digital voice recorder for identifying an article as belonging to an individual, can comprise the steps of (a) recording a voice message on a digital voice recorder having a play back means for playing back the voice message, wherein the voice message includes identification of an article as belonging to an individual; (b) setting the digital voice recorder to a play back mode; (c) optionally placing the digital voice recorder in the play back mode in a packet;(d) attaching the digital voice recorder in the play back mode to the article, wherein the attaching optionally comprises placing the digital voice recorder in a pocket of the article; (e) attaching a visible marker to a surface of the article to indicate the presence of the digital voice recorder in the play back mode; and (e) activating the play back means for playing back the voice message to identify the article as belonging to the individual.

This written description sets forth the best mode of carrying out the invention, and describes the invention so as to enable a person of ordinary skill in the art to make and use the invention, by presenting examples of the elements recited in the claims. The patentable scope of the invention is defined by the claims, and may include other examples that occur to those skilled in the art. Such other examples, which may be available either before or after the application filing date, are intended to be within the scope of the claims if they have elements that do not differ from the literal language of the claims, or if they have elements with insubstantial differences from the literal language of the claims

I claim:

1. An audible personal identification system for an article, comprising:
(a) a device programmable to record and play back a voice message that includes identification of an article as belonging to an individual;
(b) an optional packet for containing the device;
(c) a visible marker for fastening to a surface of the article to indicate the presence of the device; and
(d) an activating means for playing back the voice message.

2. The audible identification system of claim 1, wherein the device comprises a digital voice recorder.

3. The audible identification system of claim 1, wherein the article comprises a garment belonging to the individual.

4. The audible identification system of claim 1, wherein the article comprises a portable article belonging to the individual.

5. The audible identification system of claim 1, wherein the optional packet for containing the device further comprises the visible marker fastenable to a surface of the packet.

6. The audible identification system of claim 1, wherein the optional packet for containing the device comprises a means of attaching the packet to the article.

7. The audible identification system of claim 1, wherein the device is removably contained in the optional packet.

8. The audible identification system of claim 1, wherein the device is removably contained in a pocket of the article.

9. The audible identification system of claim 1, wherein the visible marker is fastenable to a surface of the article at a location of the activating means for playing back the voice message.

10. The audible identification system of claim 1, wherein the activating means comprises a play back button or switch.

11. The audible identification system of claim 10, wherein the play back button or switch is compressibly activatable by manual pressing on the article at the location of the device.

12. The audible identification system of claim 10 wherein the play back button or switch is activatable by manual squeezing of the article at the location of the device.

13. The audible identification system of claim 1, wherein the marker comprises an indicia.

14. The identification system of claim 13, wherein the indicia comprises a logo.

15. An article to be identified as belonging to an individual, comprising
(a) a device programmable to record and play back a voice message that includes identification of an article as belonging to an individual and an activating means for playing back the voice message;
(b) an optional packet for containing the device;
(c) an optional pocket of the article for containing the device; and
(c) a visible marker fastened to a surface of the article to indicate the presence of the device.

16. The article of claim 15, wherein the device comprises a digital voice recorder.

17. The article of claim 15, wherein the optional packet for containing the device further comprises the visible marker fastened to a surface of the packet to indicate the presence of the device.

18. The article of claim 15, wherein the optional packet for containing the device comprises a means for attaching the packet to the article.

19. The article of claim 15, wherein the device is removably contained in the optional packet.

20. The article of claim 15, wherein the device is removably contained in the optional pocket of the article.

21. The article of claim 15, wherein the visible marker is fastened to a surface of the article at a location of the activating means for playing back the voice message.

22. The article of claim 15, wherein the activating means comprises a play back button or switch.

23. The article of claim 22, wherein the play back button or switch is compressibly activatable by manual pressing on the article at the location of the device.

24. The article of claim 22 wherein the play back button or switch is activatable by manual squeezing of the article at the location of the device.

25. The article of claim 15, wherein the marker comprises an indicia.

26. The article of claim 25, wherein the indicia comprises a logo.

27. The article of claim 15, wherein the article comprises a garment.

28. The article of claim 15, wherein the article comprises a portable article belonging to an individual.

29. A method for identifying an article as belonging to an individual, comprising the steps of:
(a) recording a voice message on a recording device with a means for playing back the voice message, wherein the voice message includes identification of an article as belonging to an individual;
(b) setting the recording device to a play back mode;
(c) optionally placing the device in the play back mode in a packet;
(d) attaching the device in the play back mode to the article, wherein the attaching optionally comprises placing the device in a pocket of the article;
(e) attaching a visible marker to a surface of the article to indicate the presence of the device; and
(f) activating the means for playing back the voice message to identify the article as belonging to the individual.

30. A method for using a digital voice recorder for identifying an article as belonging to an individual, comprising the steps of:
(a) recording a voice message on a digital voice recorder having a play back means for playing back the voice message, wherein the voice message includes identification of an article as belonging to an individual;
(b) setting the digital voice recorder to a play back mode;
(c) optionally placing the digital voice recorder in the play back mode in a packet;
(d) attaching the digital voice recorder in the play back mode to the article, wherein the attaching optionally comprises placing the digital voice recorder in a pocket of the article;
(e) attaching a visible marker to a surface of the article to indicate the presence of the digital voice recorder in the play back mode; and
(e) activating the play back means for playing back the voice message to identify the article as belonging to the individual.
